(19) United States
(12) Patent Application Publication
(10) Pub. No.: US 2003/0150929 A1
(43) Pub. Date: Aug. 14, 2003

(54) Spinning fountain apparatus

(76) Inventor: Thomas R. Simmons, Dickinson, TX (US)

Correspondence Address: Marvin J. Marnock, 13630 Indian Creek Rd., Houston, TX, 77079-7029, US

(21) Appl. No.: 10/075,748

(22) Filed: Feb. 14, 2002

(51) Int. Cl. B05B 3/00

(52) U.S. Cl. 239/17; 239/246; 239/256

(57) ABSTRACT

A spinning fountain display comprising a rotatable object 10 and means 13 for rotating the object 10 in either direction about an axis of rotation 18. A plurality of nozzles 54, 55 open at the periphery of the object 10 and are provided by a plurality of feeder passages 50 which form single entry nozzles 54 and/or feeder passages 61, 62 which form dual entry nozzles 55 or multi-entry nozzles. The nozzle forming passages are connected as parts of a conduit system which is provided with valve means 40 for selectively connecting the passages 50, 61, 62 and the nozzles formed thereby to a pressurized source of a liquid medium for generating fountain dispersal streams therefrom, which streams are controllable in magnitude and direction whereby said object 10 may be spun in a selected direction of rotation about the axis of rotation 18 and at a selectively controlled speed and which direction may be reversed at any time by manual or electrical operation of said valve means 40 to provide an aesthetically pleasing and entertaining fountain display.

### FIELD OF THE INVENTION

The invention relates to apparatus for producing fountain displays, and more particularly to a fountain apparatus for producing a multiplicity of fountain dispersal streams and sprays which can be selectively controlled in magnitude and direction to produce a spinning display which spins about an axis of rotation at a selectvely controlled speed and direction of rotation, which direction can be readily reversed when desired.

### BACKGROUND OF THE INVENTION

Fountains are oftentimes designed for generating aesthetically pleasing and entertaining spectacles. The fountain dispersal streams and sprays may be of various shapes and sizes and may also move in a manner to produce picturesque moving images. Many such displays may utilize dual entry nozzles and alternating diverter valves or specially designed valves such as disclosed in U.S. Pat. No. 5,524,822 to produce their display, while others rely on complex mechanical systems. The present invention is directed to a unique fountain display which is adapted to spin its dispersal streams in a spinning wheel fashion and comprises apparatus which incorporates single, dual and multi-entry nozzles for generating moveable and oscillating fountain dispersal streams and whereby the magnitude of the streams, the spin speed and the direction of rotation are selectively controlled and wherein the direction of spin is readily reversible at the operator's behest or by means of electronic controls.

### SUMMARY OF THE INVENTION

The present invention is directed to a spinning fountain display wherein a rotatable object, preferably of disc shape, is mounted for rotation about an axis. The object is provided with a plurality of nozzles located and opening at its periphery and operatively associated with a conduit system including valve means therein for selectively connecting said nozzles to a pressurized source of liquid medium for generating dispersal streams from said nozzles which are controllable in magnitude and direction whereby said object may be spun in a selected direction of rotation about said axis and at a selectively controlled speed and which direction may be reversed at any time by operation of said valve means.

### BRIEF DESCRIPTION OF THE DRAWINGS

FIG. 1 is a perspective view of a rotatable object which is mounted for rotation about a rotation axis and is the principal component of the spinnable fountain of the invention;

FIG. 2 is a perspective view of an alternative embodiment of the rotatable object in FIG. 1;

FIG. 3 is a plan view of an acrylic disc which is a component of the rotatable object shown in FIG. 1 and which shows the formation of channels therein for creating tubular passages which provide single entry nozzles opening at the periphery of said object;

FIG. 4 is a plan view of an acrylic disc which is a component of the rotatable object shown in FIG. 1 and which shows the formation of multiple pairs of channels therein for creating pairs of tubular passages which provide dual entry nozzles which open at the periphery of the rotatable object;

FIG. 5 is a frontal plan view of and end disc component of the rotatable object in FIG. 1 and showing the formation of a hole therein which is concentrically aligned with the axis of rotation of said object and a radially extending feeder groove which connects to the hole for a first manifold tubular passage provided in said object;

FIG. 6 is a frontal plan view of the disc at the other end of said rotatable object in FIG. 1 and showing the provision of a central hole for receiving fluid, and a radially extending feeder groove or channel which connects to a second manifold tubular passage in said object;

FIG. 7 is a top plan view of the rotatable object in FIG. 2 and showing in dashed lines a pair of manifold feeder passages which are formed in the plurality of acrylic disc components of the rotatable object, both in parallel relation to the axis of rotation of the object with one manifold feeder passage communicating with the fluid inlet conduit at one end of the object and the other manifold feeder passage communicating with the fluid inlet conduit at the other end of the object;

FIG. 8 is a schematic which illustrates the conduit system for connecting the tubular channels in the discs shown in FIGS. 3 and 4 and the nozzles they create to a pressurized source of liquid medium;

FIG. 9 is a frontal plan view of a spinning fountain in accordance with the invention and the fountain dispersal streams issuing therefrom when rotating in a clockwise direction;

FIG. 10 is a perspective view of the spinning fountain of FIG. 8 as it appears when caused to rotate in the counterclockwise direction; and

FIGS. 11a-11c are perspective views of a plurality of rotatable objects which are not disc-like or circular cylinder in shape but which are provided with single entry and/or dual entry or multiple entry nozzles and which are mounted for rotation about an axis for providing a fountain display in accordance with the invention.

### DETAILED DESCRIPTION OF THE INVENTION

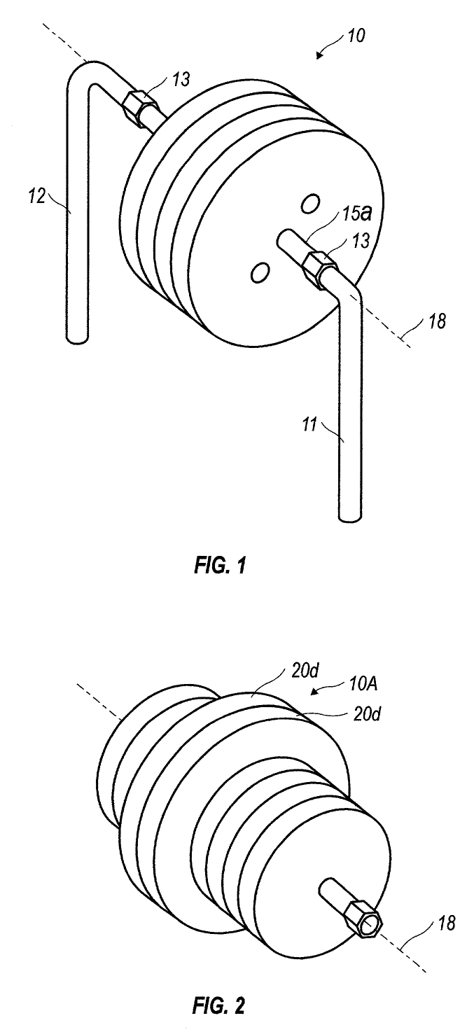

Referring more particularly to the drawings, there is shown in FIG. 1, a rotatable object 10 of circular cylinder shape which is mounted on a pair of vertical supporting pipes 11, 12 each having a horizontal branch identified respectively as 11a, 11b. At their other ends, the pipes 11, 12 are connected to a pressurized source of a liquid medium, such as water. Each horizontal branch has a swivel joint 13 which joins the horizontal branch with an axial tubular member (15a, 15b) extending respectively from each side of the rotatable object 10 and coaxially aligned with the cylindrical axis 18 of the rotatable object 10. The swivel joints permit the object 10 to rotate in either direction about the axis 18 which constitutes an axis of rotation.

The object 10 is formed by a plurality of acrylic plates of disc-like circular cylinder configuration placed in abutting laminar relationship with each other and fixed to one another by an appropriate adhesive. The disc plate 20a at one end of object 10 is provided with a central circular bore 22a to which the tubular member 15 is fitted and fixed therein in concentric relation. The next adjacent disc plate 20a is provided with a central blind bore 22b similar in transverse configuration to the bore 22a.

Another embodiment of the rotatable object 10 is shown in FIG. 2 as the object 10A which differs from the object 10 in that a pair of the disc plates are of larger diameter than the other disc plates 20. Also, the rotatable object 10A is shown to have a greater number of abutting disc plates than the object 10, thus allowing for providing the object with a greater number of nozzles, to be hereinafter described, than could be provided for the rotatable object 10 in FIG. 1.

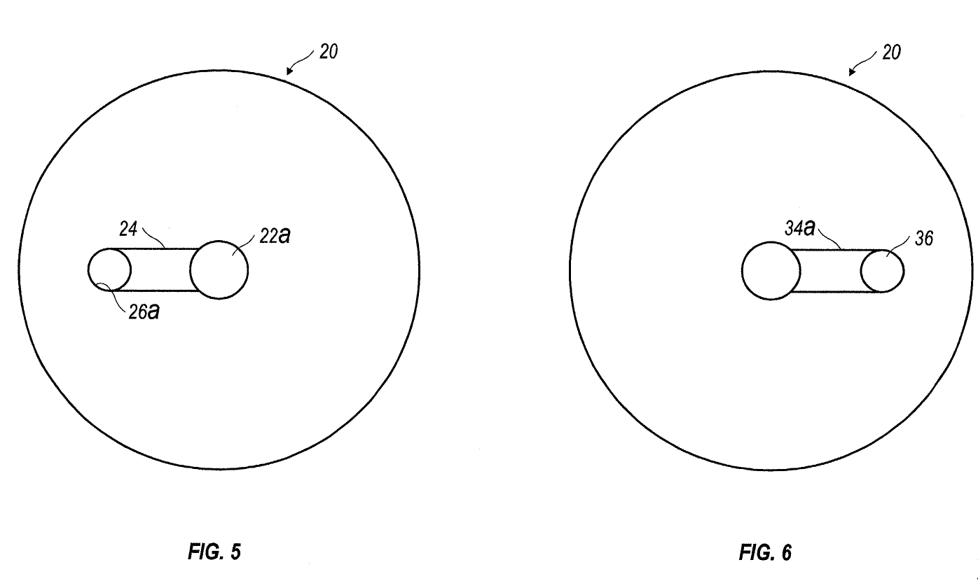

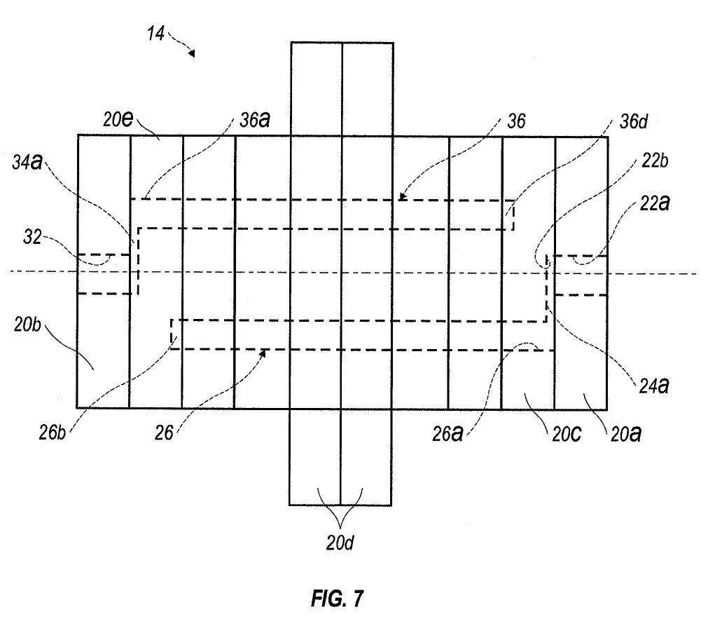

Referring to FIGS. 5 and 7, it will be seen that a feeder groove channel 24a extends radially outward from the blind bore 22b to a circular bore 26a which is formed in the disc plate 20c and forms part of manifold feeder passage 26 which is formed by aligned bores extending through abutting plates 20 as far as the blind bore 26b in the disc plate 20e adjacent to the end plate 20b at the opposite end of the rotatable object 20, as shown in FIG. 7. The manifold feeder bore 26 extends in parallel relationship with the central axis of the rotatable object 20 or 20A.

At its other end, the end plate 29b of the rotatable object is provided with a feeder bore 34a which extends radially outward from a central bore 32 in the abutting disc plates 20b and 20e to a circular bore 36a which is formed in the disc plate 20e and is part of the manifold feeder passage 36 which is formed by aligned bores extending through abutting plates as far as the blind bore 36b in the disc plate 20c.

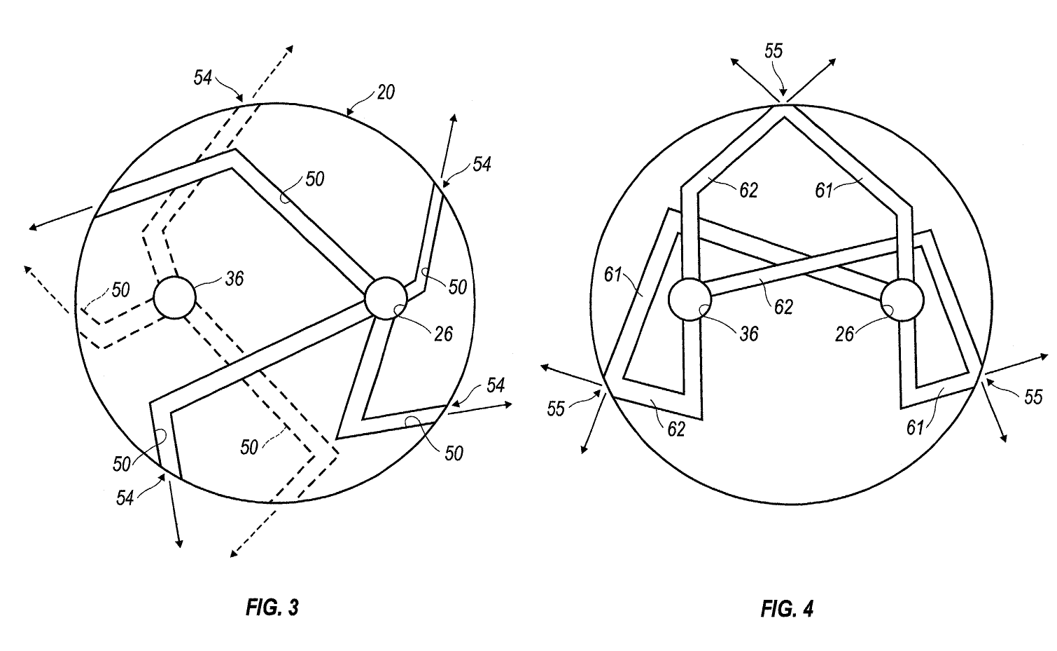

In a preferred form of the invention, the rotatable object, such as the objects 10 and 10A, are provided with a plurality of both single entry nozzles and dual entry nozzles. The single entry nozzles are oriented such that the dispersal stream issues there from in non-radial direction with respect to the axis of rotation 18 as shown in FIG. 3.

The nozzles formed at the periphery of the objects 10, 10A are dual entry nozzles of the type which provides a “stick-like” dispersal stream as described in U.S. Pat. Re. 35,866 and shown in FIG. 2 thereof. The “dual entry nozzle” is particularly suited for use where capability of a back-and-forth motion of the dispersal stream is desired, which can be accomplished by selectively increasing flow of pressurized fluid to one inlet conduit as compared with flow to the other.

A “dual-entry” nozzle as shown in FIG. 2 of said patent and which can be used in the apparatus of the invention for producing a “stick-like” dispersal stream, comprises an inverted V-shaped tube with an exit aperture provided at the apex of the tube. When two pressurized flows are delivered to the ends of the legs of the V-shaped tube, they are merged at the apex of the tube just outside the exit aperture to form the “stick-like” dispersal stream.

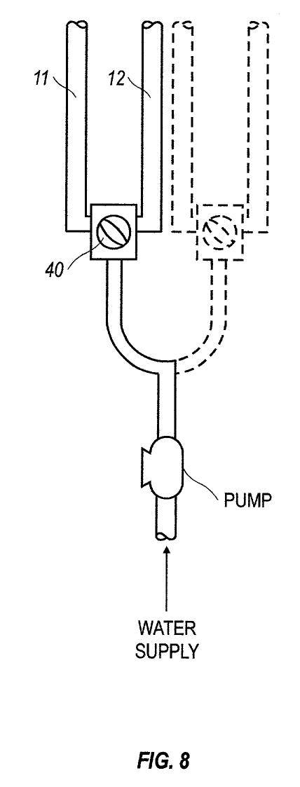

As seen in the drawings, FIG. 1, object 10 is mounted on a pair of pipes 11, 12 which extend vertically with respect to the floor and each of which is connected to a pressurized source of water. Flow to each of the pipes is selectively controlled as by a diverter valve 40 (FIG. 8) or valve as disclosed in the Reissue Patent cited above. A swivel joint is provided in each pipe 11, 12 on each side of object 10 to allow for its rotation about its central axis. Pressurized fluid is selectively supplied to the plates of the spinning disc for selective delivery to the grooves (V-legs) of the disc nozzles whereby the dispersal streams from the nozzles may be controlled in volume and direction to control the speed and direction of spin of the disc object 10.

Referring to FIG. 3, there is shown a disc plate 20 provided with manifold feeder bores 26, 36 and a plurality of channel grooves 50 formed in the circular face thereof and which extend from the feeder bore 26 to open at the periphery of the disc 20 and provide single entry nozzles 54 for the object 10. The number of such nozzles 54 is a matter of choice.

In dashed lines, a plurality of channel grooves 50a are shown exiting from the feeder bore 36 in another disc plate behind and adjacent to the disc plate 20 which has channel grooves 50.

Referring to FIG. 4, there is shown a disc plate 20 which is provided with the manifold bores 26, 36 and a plurality of channel grooves 61 which extend from the bore 26 and open at the periphery of the disc 20 in a non-radial relation to the central axis 18. The disc plate 20 is also provided with a plurality of channel grooves 62 which extend from the manifold feeder bore 36 to open at the cylindrical periphery of the disc plate 20, also in non-radial relation to the central axis 18. The grooves 61 are equal in number to the grooves 62 and each groove 61 is paired with a different one of the grooves 62 and is oriented in angular relation therewith to merge therewith and form a V-shape wherein the apex of the V shape opens at peripheral edge of the disc 20 to form a dual entry nozzle 55. The number of such nozzles formed by channels 61, 62 in a disc plate is arbitrary.

It is also to be appreciated that a rotatable object 16 might be provided with only single entry nozzles or dual entry nozzles or with the combination thereof. Also, it is possible to provide additional channel grooves in the disc plates 20 so that a multiplicity of channels formed thereby are arranged in angular relationship to merge in a number more than two with their point of juncture opening at the cylindrical peripheral edge of the disc plate and thereby provide a multi-entry nozzle (not shown) for which a dispersal stream which issues therefrom is moveable in any direction about the point of juncture of the multiple channels and not just uniplanar by controlling the relative flow of fluid in the many channels of the nozzle.

By controlling the magnitude and direction of the dispersal streams issuing from the dual entry nozzles, as when the dispersal streams are at one extremity of their range of pivotal movement, the resulting reaction force on the object 10 will induce its rotation about the axis 18. By reversing the streams to the other extremity of their range of arcuate movement, the resulting reaction force will induce rotation of object 10 in the opposite direction.

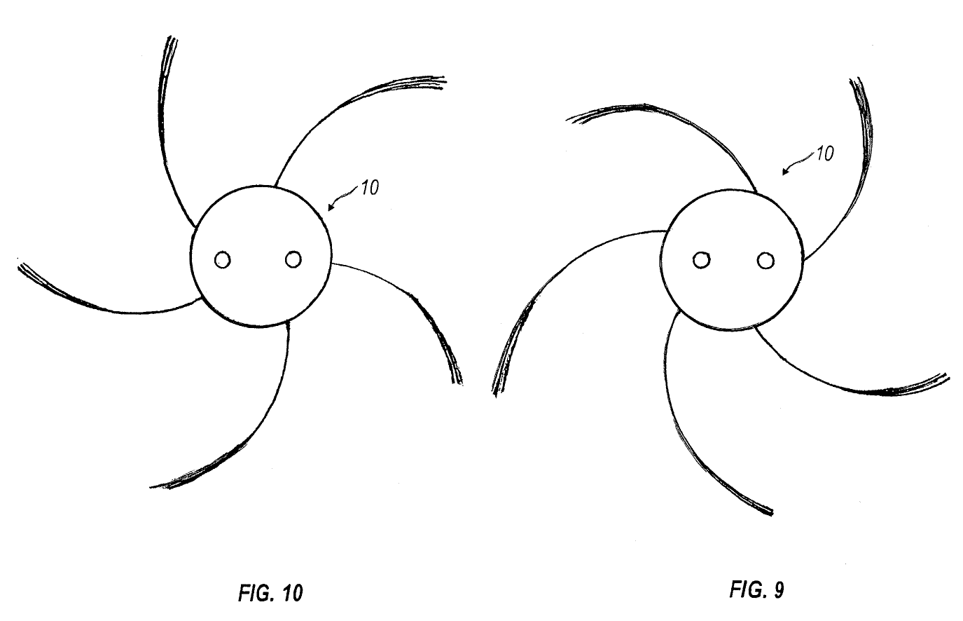

In FIG. 9, there is shown a fountain display in accordance with the invention wherein the rotatable object of the invention is rotatating in the clockwise direction. FIG. 10 shows the display when the rotatable object is rotating counterclockwise.

With respect to the single entry nozzles 54, it is to be noted that all the channels 50 leading from the feeder bore 26 and their nozzles 54 constitute a first set of nozzles whose dispersal streams issue from the disc plate 20 in the same direction, that is, in a direction such that their reaction forces are directed to the right of the disc center and the axis 18 and thereby induce a clockwise rotation of the object 10. The other channels 50, shown in dashed lines in FIG. 3, provide a second set of single entry nozzles whose dispersal streams issue in a non-radial direction with respect to the axis 18 and thereby induce a counterclockwise rotation of the object 10.

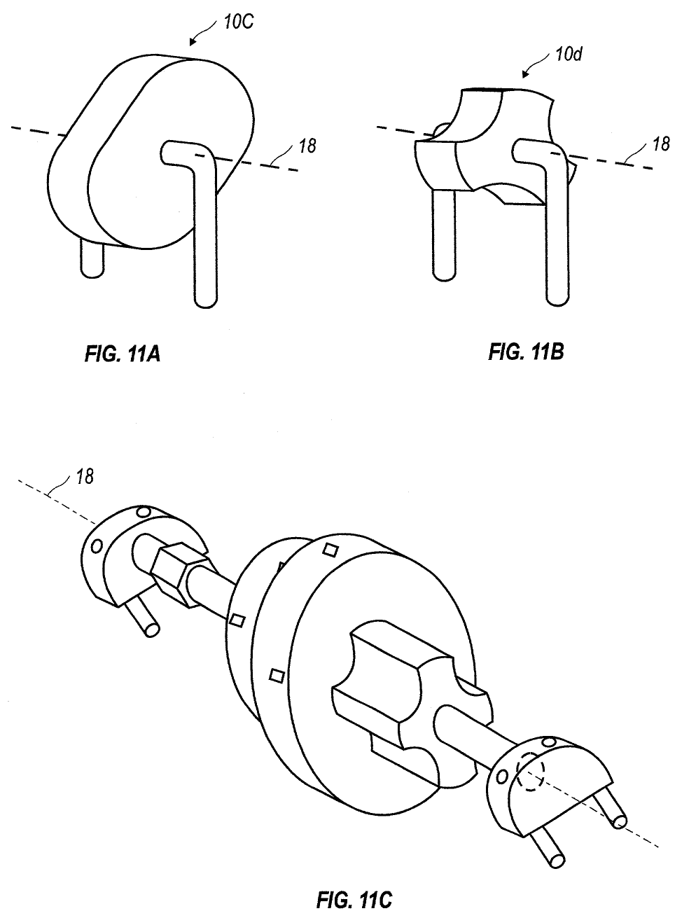

It is also to be appreciated that the rotatable object of the invention need not be of circular cylinder configuration but could have almost any shape desired such as the objects 10c and 10d shown in FIGS. 11a, 11b respectively. A more complex form of rotatable object is shown in FIG. 11c wherein a plurality of different shaped objects are placed in juxtaposition and all adapted to rotate in either direction about the axis of rotation.

It is also to be appreciated that the feeder grooves and nozzle openings may be circular in transverse cross section or square or rectangular. As a rule, the dispersal streams from the square or rectangular feeder grooves and nozzles maintain their shape for a much greater distance from the nozzle apertures than do the circular variety. Also, the disc plate 20 might be of circular cylinder form or another shape such as oval or rectangular. It might also be transparent or translucent plastic, other than acrylic and all kinds of lighting and the use of mirrors employed for illuminating the display.

It is also to be appreciated that when the dual entry dispersal streams are placed at one extremity of their range of movement as to induce a clockwise rotation, they are grouped with the first set of single entry nozzles which also induce a clockwise rotation. When the dual entry dispersal streams are at their other extremity of movement they are grouped with the second set of single entry valves.

It is also to be understood that the foregoing descriptions of various embodiments of the fountain display of the invention have been presented for purposes of illustration and explanation and are not intended to limit the invention to the precise forms disclosed. For example, the rotatable object could be formed in a mold with the several channel passages and feeder bores included therein. Also, the passages might be provided by pipes or the like and the pipes rotated as a rotatable object. It is to be appreciated therefore, that various material and structural changes may be made to the spinnable fountain display of the invention by those skilled in the art without departing from the spirit of the invention.

What is claimed is:

1. A spinnable fountain apparatus for producing fountain dispersal streams and which is adapted to be spun at selectively controlled speed and reversible direction to provide an aesthetically pleasing display, said apparatus comprising:
a rotatable object;
means for mounting said object whereby said object is rotatable in either direction about an axis of rotation passing through said object;
a plurality of single entry nozzles opening at the peripheral edge of said object, said single entry nozzles being provided by tubular passages formed in said object and comprising first and second sets of tubular passages wherein each passage in said first set is connectable at one end to a source of pressurized liquid medium and extends to the periphery of said object in a non-radial direction with respect to the axis of rotation to provide a single entry nozzle which opens at the periphery of said object such that a liquid dispersal stream issuing from the nozzle generates a reaction thrust force which induces a clockwise rotation of said object about said axis of rotation, and wherein each tubular passage in said second set is connectable to a pressurized source of liquid medium and extends to the periphery of said object in a non-radial direction with respect to said axis of rotation to provide a single entry nozzle which opens at the periphery of said object such that a liquid dispersal stream issuing from the nozzle generates a reaction thrust force which induces a counterclockwise rotation of said object about said axis of rotation;
a conduit system connecting each said tubular passage to a pressurized source of liquid medium; and
valve means in said conduit system for selectively connecting one of said sets of tubular passages and the nozzles formed therewith to said pressurized source of liquid medium and thereby selectively inducing the rotation of said object said rotation axis in a given direction of rotation, which direction is reversible by operation of said valve means to alternatively connect the other set of tubular passages to said pressurized source of liquid medium.

2. A spinnable fountain apparatus for producing fountain streams and sprays and which is adapted to be spun at selectively controlled speeds and readily reversible direction to provide an aesthetically pleasing and entertaining display, said apparatus comprising:
a rotatable object;
means for mounting said object whereby said object is rotatable in either direction about an axis of rotation;
a plurality of dual entry nozzles opening at the edge of said rotatable in spaced relation to one another, said dual entry nozzles being provided by pairs of tubular passages formed in said object wherein each passage in said pair is connectable at one end to a source of pressurized liquid medium and is oriented in V-shape relation with the other passage of said pair and joins therewith to form a dual entry nozzle with its exit port at the periphery of said object such that flows of liquid medium delivered to each of said pairs of tubular passages form a single merged dispersal stream;
a conduit system connecting each said tubular passage to a pressurized source of liquid medium; and
valve means in said conduit system for controlling the flow of liquid medium to each passage in each said pair of passages such that the dispersal stream issuing from the nozzle provided by said joined pair can be pivotally moved about their point of juncture in a range of movement corresponding to the angular relationship of the joined pair of tubular passages and whereby when the dispersal stream is in a fixed position at one extremity of its range of arcuate movement the resulting reaction thrust on said object induces rotation of said object in a selected direction of rotation and which is reversible in direction by operation of said valve means to position the dispersal stream at the other extremity of its range of movement.

3. A spinnable fountain apparatus for producing fountain sprays and streams and which is adapted to be spun at selectively controlled speed and reversible direction to provide an aesthetically pleasing display, said apparatus comprising:
a rotatable object;
means for mounting said object whereby said object is rotatable in either direction about an axis of rotation passing through said object;
a plurality of single entry nozzles opening at the peripheral edge of said rotatable object, said single entry nozzles being provided by tubular passages formed in said object and comprising first and second sets of tubular passages wherein each passage in said first set is connectable at one end to a source of pressurized liquid medium and extends to the periphery of said object in a non-radial direction with respect to the axis of rotation to provide a single entry nozzle which opens at the periphery of said object such that a liquid dispersal stream issuing from the nozzle generates a reaction thrust force which induces a clockwise rotation of said object about said axis of rotation, and wherein each tubular passage in said second set is connectable to a source of pressurized liquid medium and extends to the periphery of said object in a non-radial direction with respect to said axis of rotation to provide a single entry nozzle which opens at the periphery of said object such that a liquid dispersal stream issuing from the nozzle generates a reaction thrust force which induces a counterclockwise rotation of said object about the axis of rotation;
a plurality of dual entry nozzles opening at the peripheral edge of said rotatable object in spaced relation to one another, said dual entry nozzles being provided by pairs of tubular passages formed in said object wherein each passage in said pair is connectable at one end to said pressurized source of liquid medium and is oriented in V-shape relation with the other passage of said pair and joins therewith to form a dual entry nozzle with its exit port at the periphery of said object such that flows of liquid medium delivered to each of the tubular passages in each said pair are merged to form a single dispersal stream which can be pivotally moved about their point of juncture in a range of movement corresponding to the angular relationship of the joined pair of tubular passages and whereby when the dispersal stream is in a fixed position at one extremity of ita range of arcuate movement the resulting reaction thrust on said object induces rotation of said object in a given direction of rotation and which is reversible in direction of rotation when the dispersal stream is positioned at the other extremity of its range of arcuate movement;
a conduit system connecting each said tubular passage in each of said pairs to said pressurized source of liquid medium;
valve means in said conduit system for selectively connecting one of said sets of tubular passages and the single entry nozzles formed thereby and for selectively connecting the tubular passages in each said pair which forms a dual entry nozzle to a pressurized source of liquid medium whereby the resulting reaction thrust force of all the dispersal streams results in a selected direction of rotation of said object and at a selected speed and which direction of rotation is reversible by operation of said valve means.

4. A spinnable fountain apparatus for producing fountain dispersal streams as set forth in claims 1, 2 and 3 and wherein said rotatable object has a cylindrical outer surface at the periphery thereof with the cylindrical axis of said cylindrical surface corresponding to the axis of rotation of said object.

5. A spinnable fountain apparatus as set forth in claim 4 wherein said cylindrical surface is a circular cylinder.

6. A spinnable fountain apparatus for producing fountain dispersal streams and which is adapted to be spun at selectively controlled speeds and reversible direction to provide an aesthetically pleasing display, said apparatus comprising:
a rotatable object;
means for mounting said object whereby said object is rotatable in either direction about an axis of rotation;
a plurality of nozzles opening at the periphery of said object, said nozzles being provided by tubular passages formed in said object and opening in said periphery, said nozzles comprising first and second groups of said tubular passages and wherein each passage in said first group is connectable to a source of pressurized liquid medium and extends to the periphery of said object in a non-radial direction with respect to said axis of rotation such that a liquid dispersal stream issuing therefrom generates a reaction thrust force which induces a clockwise rotation of said object and wherein each tubular passage in said second group is connectable to said source of pressurized liquid medium and extends to the periphery of said object in a different non-radial direction than the direction of said first group such that a liquid dispersal stream issuing from each nozzle formed by said second group generates a reaction thrust force which induces a counterclockwise rotation of said object;
a conduit system connecting each of said tubular passages to a pressurized source of liquid medium; and
valve means in said conduit system for selectively connecting said pressurized source of liquid medium to either of said groups in a controlled manner to thereby determine the direction of rotation of said object and its speed of rotation.

7. A spinnable fountain apparatus as set forth in claim 6 wherein at least one of said groups of tubular passages forms at least one multiple entry nozzle opening at the periphery of said object.

8. A spinnable fountain apparatus for producing fountain dispersal streams and which is adapted to be spun at selectively controlled speed and reversible direction to provide an aesthetically pleasing display, said apparatus comprising:
means providing a plurality of tubular passages for liquid flow therethrough, said passages comprising first and second groups of passages;
mounting means for mounting said means for providing tubular passages whereby said tubular passages in both said groups are rotatable about an axis of rotation in either direction of rotation;
a first group of nozzles being provided by said first group of tubular passages, each tubular passage in said first group extending in an outward direction with respect to said axis of rotation such that a liquid dispersal stream issuing from the nozzles provided by said first group generates a reaction thrust force which induces a clockwise rotation of said first group of nozzles about said axis of rotation;
a second group of nozzles being provided by said second group of tubular passages, each tubular passage in said second group extending outward with respect to said axis of rotation such that a liquid dispersal stream issuing from the nozzles provided by said second group generates a reaction thrust force which induces a counterclockwise rotation of said second group of nozzles about said axis of rotation;
a conduit system connecting each said tubular passage in both said groups of passages to a pressurized source of liquid medium;
and valve means in said conduit system for selectively connecting one of said groups of tubular passages and the nozzles provided thereby to said pressurized source of liquid medium and thereby selectively inducing rotation of said selected group of nozzles in a given direction of rotation about said axis of rotation, said valve means being operatice to selectively connect the other of said groups of tubular passages and the nozzles provided tereby to said source of pressurized source of liquid medium to thereby reverse the rotation of all of said nozzles about said axis of rotation.

9. A spinnable fountain apparatus as set forth in claim 8 wherein the nozzle-forming channels are of rectangular shape in transverse cross section and the nozzle openings are rectangular in shape.

10. A spinnable fountain apparatus as set forth in claim 8 wherein the nozzle-forming channels are of square shape in transverse cross section and the nozzle openings are square in shape.
